(19) United States
(12) Patent Application Publication
(10) Pub. No.: US 2023/0257527 A1
(43) Pub. Date: Aug. 17, 2023

(54) HYBRID SILOXANE OLIGOMERS

(71) Applicant: MOMENTIVE PERFORMANCE MATERIALS INC., Waterford, NY (US)

(72) Inventors: Raghavendra HEBBAR, Bangalore (IN); Hao SHEN, Verona, NJ (US); Banpreet KAUR, New Delhi (IN); Karthikeyan SIVASUBRAMANIAN, Bangalore (IN); Shreedhar BHAT, Bangalore (IN)

(21) Appl. No.: 18/011,546

(22) PCT Filed: Jul. 1, 2021
(86) PCT No.: PCT/US2021/040086

§ 371 Date: Dec. 20, 2022

Related U.S. Application Data
(60) Provisional application No. 63/047,484, filed on Jul. 2, 2020.

(51) Int. Cl. C08G 77/14; C09D 183/10; C09D 183/08; C08G 77/26

(52) U.S. Cl. CPC C08G 77/14; C09D 183/10; C09D 183/08; C08G 77/26

(57) ABSTRACT

A hybrid siloxane oligomer is shown and described herein. A hybrid siloxane oligomer comprises organosilicon units wherein the oligomer comprises organosilicon units with fluoro-functional groups, and organosilicon units with other reactive functionality. The oligomers can be employed to form a coating on a surface of an article to provide a hydrophobic and/or oleophobic surface coating, which may impart other beneficial properties to the article.

### CROSS-REFERENCE TO RELATED APPLICATIONS

This application claims priority to and the benefit of U.S. Provisional Patent Application No. 63/047,484 titled “HYBRID SILOXANE OLIGOMERS” filed on Jul. 2, 2020, the disclosure of which is incorporated herein by reference in its entirety.

### FIELD OF INVENTION

The present invention relates to siloxane oligomers. In particular, the present invention relates to hybrid siloxane oligomers comprising fluoro-functional groups and a reactive functional group, compositions comprising such oligomers, coatings formed from such compositions, and articles comprising such coatings.

### BACKGROUND

Coatings that exhibit hydrophobic and/or oleophobic properties are of interest to protect surfaces exposed to various conditions including environmental conditions. Coatings that exhibit hydrophobic or oleophobic properties exhibit relatively large water contact angle or oil contact angle, respectively, to impart roll-off properties, weather resistance, and durability to a surface of an article coated with such materials.

Generally, a surface is considered hydrophobic or oleophobic if the water contact angle or oil contact angle, respectively, is greater than 90°. An example of a hydrophobic surface is a polytetrafluoroethylene (Teflon™) surface. Water contact angles on a polytetrafluoroethylene surface can reach about 115°. Surfaces with a water contact angle greater or an oil contact angle greater than 130° are considered “superhydrophobic” or “superoleophobic,” respectively. Superhydrophobic or superoleophobic coatings display a “self-cleaning” property, in which dirt or spores, bacteria, or other microorganisms that come into contact with the surface are unable to adhere to the coating and are readily washed away with water. Further, the extreme water repellency of such coatings gives the surface anti fouling, anti-icing, and/or anti-corrosion properties.

Roll-off angle is the smallest possible angle of inclination of the surface under test, with respect to the horizontal, which is sufficient to cause the liquid drop to move away from this surface. Roll-off angle and hysteresis of a water droplet indicates the stability of the droplet on the surface; the lower the value for these two parameters, the less the stability of the droplet and therefore, the easier the roll-off of the droplet from the surface.

Typically superhydrophobic and/or superoleophobic surfaces are created by changing the surface chemistry and/or by increasing the surface roughness via surface texturing so as to increase the true or effective surface area, or a combination of both methods. Surface texturing may be cumbersome and expensive. Further, it can be difficult to achieve for large and complex articles. Superhydrophobic surfaces have also been produced by multi-layered techniques involving the formation of a first layer of surface roughness followed by chemical treatment with a fluorinated surface modifier. A superhydrophobic and/or superoleophobic surface can be created by chemical methods by coating the surface of an article with a superhydrophobic and/or superoleophobic coating, layer, or a film. Coating the surface with a superhydrophobic/superoleophobic coating is a very efficient means of converting any surface into a superhydrophobic/superoleophobic surface. However, most of such superhydrophobic/superoleophobic coatings suffer from poor adhesion to the surface, lack mechanical robustness, and are prone to scratches.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, provided is a hybrid siloxane oligomer of the formula:

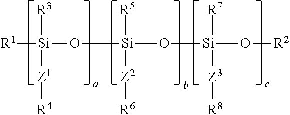

where R¹, R³, R⁵, and R⁷ are each independently selected from hydroxy, an alkoxy, an alkoxycarbonyl, a halide, an alkyl, an aralkyl, or an aromatic group, with the proviso that at least one of R¹, R³, R⁵, and/or R⁷ is an alkoxy, an alkoxycarbonyl, or a halide group;
R² is selected from hydrogen an alkyl, an aralkyl, or an aromatic group;
R⁴ is selected from a fluoro-functional group;
R⁶ and R⁸ are each independently selected from an alkoxy, an alkoxycarbonyl, a halide, an alkyl, an aralkyl, an aromatic group, an epoxy, a hydroxy, an amine containing group, a mercapto containing group, a urea containing group, a thiourea containing group, and a urethane containing group;
Z¹, Z², and Z³ are each independently selected from an organic linking group having 1-20 carbon atoms optionally containing heteroatoms, with the proviso that when R⁶ or R⁸ is an alkoxy, an alkoxycarbonyl, or a halide, then Z² or Z³, respectively, cannot be O, N, or S; a is from greater than 0 to about 100, b and c are each independently 0 to about 100, a+b+c is greater than 0, and b+c is greater than 0.

In one embodiment, R⁴ is a fluoroaliphatic group of the formula C_{z}H_{y}Fₓ where z is 1-20 and x+y is 2z+1 where x is 1 or greater.

In one embodiment, R4 is selected from —CF₃, —C₂F₅, —C₃F₇, —C₄F₉, —C₅F₁₁, or —C₆F₁₃.

In one embodiment of the siloxane oligomer of any previous embodiment, R⁶ and R⁸ are each independently selected from (i) an amine group selected from —NR₂¹², —(NR¹³)ₕ—NR¹⁴R¹⁵, —NR¹⁶—C(X¹)—NR₂¹⁷, —R¹⁸—N(R¹⁹)—R²⁰, —R²¹—NR₂²²—R²³—(N(R²⁴))ᵢ—R²⁵—N₂²⁶ or a combination of two or more thereof, where R¹², R¹³, R¹⁴, R¹⁵, R¹⁶, R¹⁷, R¹⁹, R²², R²⁴, and R²⁶ are each independently selected from hydrogen, C1-C20 alkyl, a C6-C20 cycloalkyl, or a C6-C20 aromatic, R¹⁸, R²⁰, R²¹, R²³, and R²⁵ are each independently selected from a divalent C1-C20 alkyl, a C6-C20 cycloalkyl, or a C6-C20 aromatic group, X¹ is 0 or S, h is 1 to about 10, and i is 1 to about 10; (ii) an epoxy functional group selected from —R²⁹-epoxy; or —R³⁰—O—R³¹-epoxy, where R²⁹, R³⁰, and R³¹ are each independently selected from a divalent C1-C20 alkyl, a C6-C20 cycloalkyl, or a C6-C20 aromatic, or wherein R²⁹ and R³¹ can optionally be a ring structure to form a C5-C20 cycloalkyl epoxy; and (iii) a thiol containing group selected from —SH, —SR²⁷, —S—C(O)—R²⁸, or a combination of two or more thereof, where R²⁷ and R²⁸ are each independently selected from a C1-C10 alkyl, a C6-C20 cycloalkyl, and a C6-C20 aromatic.

In one embodiment of the siloxane oligomer of any previous embodiment, b is greater than 0 and R⁶ is selected from

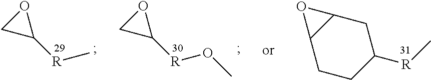

where R²⁹, R³⁰, and R³¹ are each independently selected from a divalent C1-C20 alkyl, a C6-C20 cycloalkyl, or a C6-C20 aromatic.

In one embodiment, b is greater than 0, c is 0, and R⁶ is —R³⁰—O—R³¹-epoxy, where R³⁰ and R³¹ are each independently selected from a divalent C1-C20 alkyl, a C6-C20 cycloalkyl, or a C6-C20 aromatic.

In one embodiment of the siloxane oligomer of any previous embodiment, b is greater than 0 and R⁶ is selected from —NR₂¹², —(NR¹³)ₕ—NR¹⁴R¹⁵, —NR¹⁶—C(X¹)—NR₂¹⁷, —R¹⁸—N(R¹⁹)—R²⁰, —R²¹—NR₂²², —R²³—(N(R²⁴))ᵢ—R²⁵—NR₂²⁶, or a combination of two or more thereof, where R¹², R¹³, R¹⁴, R¹⁵, R¹⁶, R¹⁷, R¹⁹, R²², R²⁴, and R²⁶ are each independently selected from hydrogen, C1-C20 alkyl, a C6-C20 cycloalkyl, or a C6-C20 aromatic, R¹⁸, R²⁰, R²¹, R²³, and R²⁵ are each independently selected from a divalent C1-C20 alkyl, a C6-C20 cycloalkyl, or a C6-C20 aromatic group, X¹ is O or S, h is 1 to about 10, and i is 1 to about 10.

In one embodiment, R⁶ is selected from —NH₂, —N(CH₃)₂, —NH—C(O)—NH₂, —NH—C(S)—NH₂, —(NH(C₂H₄)—)₂NH₂.

In one embodiment of the siloxane oligomer of any previous embodiment, b is greater than 0, c is 0, and R⁶ is —NR₂¹² and R¹² is hydrogen or a C1-C20 alkyl.

In one embodiment of the siloxane oligomer of any previous embodiment, b is greater than 0, c is 0, and R⁶ is —R¹⁸—N(R¹⁹)—R²⁰, or —R²³—(N(R²⁴))ᵢ—R²⁵—NR₂²⁶ where R¹⁹, R²², R²⁴, and R²⁶ are each hydrogen, and R¹⁸, R²⁰, and R²⁵ are each independently selected from a divalent C1-C20 alkyl

In one embodiment of the siloxane oligomer of any previous embodiment, the siloxane oligomer has a molar ratio of R⁴:(R⁶+R⁸) is from about 1:9 to about 9:1.

In one embodiment of the siloxane oligomer of any previous embodiment, the siloxane oligomer has a molar ratio of R⁴:(R⁶+R⁸) is from about 1:7 to about 7:1.

In one embodiment of the siloxane oligomer of any previous embodiment, the siloxane oligomer has a molar ratio of R⁴:(R⁶+R⁸) is from about 1:5 to about 5:1.

In one embodiment of the siloxane oligomer of any previous embodiment, the siloxane oligomer has a molar ratio of R⁴:(R⁶+R⁸) is from about 1:3 to about 3:1.

In one embodiment of the siloxane oligomer of any previous embodiment, the siloxane oligomer has having a molar ratio of R⁴:(R⁶+R⁸) is from about 1:2 to about 2:1.

In one embodiment of the siloxane oligomer of any previous embodiment, the siloxane oligomer has a molar ratio of R⁴:(R⁶+R⁸) is from about 1:1 to about 4:1.

In one embodiment of the siloxane oligomer of any previous embodiment, the siloxane oligomer has a molar ratio of R⁴:(R⁶+R⁸) is from about 1.5:1 to about 3:1.

In one embodiment of the siloxane oligomer of any previous embodiment, the siloxane oligomer has a number average molecular weight of from about 300 to about 10000.

In another aspect, provided is a composition comprising the siloxane oligomer of any of the previous embodiments dispersed in a carrier. In one embodiment, the carrier is selected from an organic solvent.

In yet another aspect, provided is a coating formed from the composition of any of the previous embodiments.

In still yet another aspect, provide is an article comprising a coating on a surface thereof, wherein the coating is formed from a composition in accordance with any of the previous embodiments.

Provided is a hybrid siloxane oligomer useful for forming a coating or as an additive in a coating to provide the coating with certain functional properties. The hybrid siloxane oligomer is a co-oligomer comprising siloxane units functionalized with a fluoro-functional group and siloxane units functionalized with a reactive group and non-reactive group. The oligomers can be hydrolyzed and condensed to provide a coating that can exhibit hydrophobic and/or oleophobic properties. The coatings can be adhered to a variety of materials such that the coatings can be useful to protect a variety of articles and substrates.

The following description and the drawings disclose various illustrative aspects. Some improvements and novel aspects may be expressly identified, while others may be apparent from the description and drawings.

### BRIEF DESCRIPTION OF THE DRAWINGS

The accompanying drawings illustrate various systems, apparatuses, devices and related methods, in which like reference characters refer to like parts throughout, and in which:

FIG. 1 shows embodiments of oligomer repeating units in accordance with aspects and embodiments of the invention.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Disclosed herein is a hybrid siloxane oligomer suitable for forming a coating or which may be used as an additive in a coating formulation. The coating can impart water resistance, oil resistance, and other properties to an article having a surface thereof coated with the composition. The hybrid siloxane oligomer is a siloxane functional oligomer comprising a fluoro-functional group and a reactive and/or non-reactive functional group. The reactive functional groups allow for the oligomers to be hydrolyzed and condensed to form a coating on a surface. Further, the fluoro-functional groups and other functional groups of the siloxane oligomer provide additional properties, e.g., hydrophobic and/or oleophobic properties, antifouling, etc., to a surface upon coating.

The hybrid siloxane oligomer, in one embodiment, is a compound of the formula:

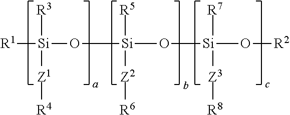

where R¹, R³, R⁵, and R⁷ are each independently selected from hydroxy, an alkoxy, an alkoxycarbonyl, a halide, an alkyl, an aralkyl, or an aromatic group, with the proviso that at least one of R¹, R³, R⁵, and/or R⁷ is an alkoxy, an alkoxycarbonyl, or a halide group;
R² is selected from hydrogen, an alkyl, an aralkyl, or an aromatic group;
R⁴ is selected from a fluoro-functional group;
R⁶ and R⁸ are each independently selected from an alkoxy, an alkoxycarbonyl, a halide, an alkyl, an aralkyl, an aromatic group, an epoxy, a hydroxy, an amine containing group, a mercapto containing group, a urea containing group, a thiourea containing group, and a urethane containing group;
Z¹, Z², and Z³ are each independently selected from an organic linking group having 1-20 carbon atoms optionally containing heteroatoms, with the proviso that when R⁶ or R⁸ is an alkoxy, an alkoxycarbonyl, or a halide, then Z² or Z³, respectively, cannot be O, N, or S;
a is from greater than 0 to about 100, b and c are each independently from 0 to about 100, a+b+c is greater than 0, and b+c is greater than 0.

The alkoxy group can be selected from a group —OR⁹ where R⁹ is a C1-C10 alkyl, a C2-C8 alkyl, or a C4-C6 alkyl. In one embodiment, the alkoxy group is —OCH₃.

The alkoxycarbonyl group can be selected form a group of the formula —O—C(O)—OR¹⁰, where R¹⁰ is a C1-C10 alkyl, a C2-C8 alkyl, or a C4-C6 alkyl. In one embodiment, the alkoxycarbonyl group is —O—C(O)—OCH₃.

The halide group can be selected from Br, C1, F, or I. In one embodiment when at least one of R¹, R³, R⁵, R⁷, R⁶, or R⁸ is a halide, the halide is F.

Where the R groups are alkyl groups, the alkyl groups can be selected from a linear, branched, or cyclic alkyl group. In one embodiment, the alkyl group is selected from a C1-C20 alkyl, a C2-C16 alkyl, a C3-C10 alkyl, or a C4-C6 alkyl. In one embodiment, the alkyl group is selected from a C4-C20 cyclic alkyl, a C5-C16 cyclic alkyl, or a C6-C10 cyclic alkyl. In embodiments, the alkyl group is selected from methyl, ethyl, propyl, isopropyl, butyl, isobutyl, t-butyl, pentyl, hexyl, heptyl, octyl, nonyl, decyl, etc.

Where the R groups are alcohol groups, the alcohol groups can be selected from —OH or —R¹¹OH, where R¹¹ is a C1-C10 alkyl group.

Where the R groups are aromatic groups, the aromatic groups can be selected from an aromatic hydrocarbon from which one hydrogen atom has been removed. An aromatic group may have one or more aromatic rings, which may be fused, or connected by single bonds or other groups. In embodiments, an aromatic group may be chosen from a C6-C30 aromatic, a C6-C20 aromatic, even a C6-C10 aromatic. Specific and non-limiting examples of aromatic groups include, but are not limited to, tolyl, xylyl, phenyl, and naphthalenyl.

R⁴ is selected from a fluoro-functional group. The fluoro-functional group can be selected from a fluoroaliphatic group or a fluoroaromatic group optionally containing heteroatoms. The fluoroaliphatic group or the fluoroaromatic group can be a group in which one or more but of, fewer than all, the hydrogen atoms are replaced with a fluorine atom. In one embodiment, the fluoro-functional group is a perfluorinated aliphatic or aromatic group in which all the hydrogen atoms are replaced by a fluorine atom.

In one embodiment, the fluoro-functional group is a fluoroaliphatic group of the formula: C_{z}H_{y}F_{X} where z is 1-20 and x+y is 2z+1 where x is 1 or greater. In on embodiment, z is 1 to about 20, about 2 to about 10, or about 4 to about 6. In one embodiment, when y is 0, the fluoro-functional group is a perfluorinated aliphatic group of the formula C_{z}F2_{z+1}. In one embodiment, the fluoro-functional group is selected from —CF₃, —C₂F₅, —C₃F₇, —C₄F₉, —C₅F₁₁, or —C₆F₁₃.

R⁶ and R⁸ are each independently selected from an alkoxy, an alkoxycarbonyl, a halide, an alkyl, an aralkyl, an aromatic group, an epoxy, a hydroxy, an amine, a mercapto, a urea, a thiourea, and a urethane. The alkoxy, alkoxycarbonyl, halide, alkyl, and aromatic groups can be selected from any such group as previously described herein.

In one embodiment R⁶ and R⁸ can be selected from an amine containing functional group. The amine can be substituted with H, an alkyl group, a cycloalkyl group, or an aromatic group. The amine can also be chosen from a polyamine group. In one embodiment, the amine group is selected from —NR₂¹², —(NR¹³)ₕ—NR¹⁴R¹⁵, —NR¹⁶—C(X¹)—NR₂¹⁷, —R¹⁸—N(R¹⁹)—R²⁰,

—R²¹—NR₂²², —R²³—(N(R²⁴))ᵢ—R²⁵—N₂²⁶, or a combination of two or more thereof, where R¹², R¹³, R¹⁴, R¹⁵, R¹⁶, R¹⁷, R¹⁹, R²², R²⁴, and R²⁶ are each independently selected from hydrogen, C1-C20 alkyl, a C6-C20 cycloalkyl, or a C6-C20 aromatic, R¹⁸, R²⁰, R²¹, R²³, and R²⁵ are each independently selected from a divalent C1-C20 alkyl, a C6-C20 cycloalkyl, or a C6-C20 aromatic group, X¹ is O or S, h is 1 to about 10, and i is 1 to about 10. In embodiments, the amine is selected from —NH₂, —N(CH₃)₂, —NH—C(O)—NH₂, —NH—C(S)—NH₂, —(NH(C₂H₄)—)₂NH₂, or a combination of two or more thereof.

In one embodiment, R⁶ and R⁸ can be selected from a thiol (—SH) containing group. Examples of thiol containing groups include, but are not limited to, —SH, —SR²⁷, —S—C(O)—R²⁸, or a combination of two or more thereof, where R²⁷ and R²⁸ are each independently selected from a C1-C10 alkyl, a C6-C20 cycloalkyl, and a C6-C20 aromatic.

In one embodiment, R⁶ and R⁸ can be selected from an epoxy functional group. The epoxy functional group can be selected from —R²⁹-epoxy; or —R³⁰—O—R³¹-epoxy, where R²⁹, R³⁰, and R³¹ are independently selected from a divalent C1-C20 alkyl, a C6-C20 cycloalkyl, or a C6-C20 aromatic, R²⁹ and R³¹ can also be or can be a ring structure to form a C5-C₂₀ cycloalkyl epoxy. In one embodiment, the epoxy functional group can be selected from a group of the formula:

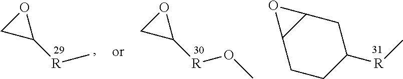

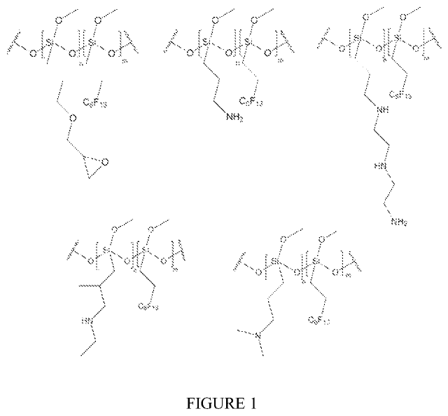

FIG. 1 shows some non-limiting examples of hybrid oligomers within the scope of the present technology.

The hybrid oligomers are provided such that the molar ratio of fluoro groups (R⁴) to the organo functional groups (R⁶ and/or R⁸) is from about 1:9 to about 9:1, from about 1:7 to about 7:1, from about 1:5 to about 5:1; from about 1:3 to about 3:1, from about 1:2 to about 2:1, or about 1:1. In one embodiment, the molar ratio of fluoro groups to organo functional groups is about 1:1 to about 4:1, from about 1.5:1 to about 3:1, or about 2:1 to about 2.5:1.

In one embodiment, the hybrid siloxane (and its partially hydrolyzed condensate) has a number average molecular weight preferably of at least about 300, more preferably at least about 500, more preferably at least about 1000. In one embodiment, the number average molecular weight of the hybrid siloxane compound (1) (and the compound's partially hydrolyzed condensate) are at most about 10000, at most about 5000, or at most about 3000. In embodiments, the number average molecular weight is from about 300 to about 10000, from about 500 to about 7500, from about 1000 to about 5000, or from about 2000 to about 3000. As used herein, the “number average molecular weight” is measured by GPC (Gel Permeation Chromatography) analysis.

The hybrid siloxane oligomers are generally prepared by reacting a fluorosilane with an appropriate reactive and/or non-reactive functional silane in the presence of a solvent and a catalyst. The silanes can be reacted at a temperature of from about 20° C. to about 60° C. Following the reaction, any water or volatiles can be removed to obtain the hybrid siloxane oligomer product. In one embodiment, a hybrid siloxane oligomer can be prepared by the reaction of a silane (R⁴—Z¹)Si(OR³)₂(OR¹) with the silanes (R⁶—Z²)Si(OR⁵)₃₋ₙ(OR²)ₙ and/or (R⁸—Z³)Si(OR⁷)₂(OR²), where R¹, R², R³, R⁴, R⁵, R⁶, R⁷, R⁸, Z¹, Z², and Z³ are as described above. The respective silanes can be provided in the desired molar ratios (satisfying a, b, and c as described above). The solvent can be selected as desired for a particular purpose or intended application. In embodiments, the solvent can be an alcohol (e.g., a C1-C10 alcohol) or a fluoro substituted alcohol. In one embodiment, the solvent is selected from methanol or trifluoroethanol.

The catalyst can be selected as desired for a particular purpose or intended application. Examples of suitable solvents include, but are not limited to, hydrochloric acid, nitric acid, sulfuric acid, phosphoric acid, fluoric acid, formic acid, acetic acid, propionic acid, butanoic acid, pentanoic acid, hexanoic acid, monochloroacetic acid, dichloroacetic acid, trichloroacetic acid, trifluoroacetic acid, oxalic acid, malonic acid, sulfonic acid, phthalic acid, fumaric acid, citric acid, maleic acid, methylmalonic acid, adipic acid, p-toluenesulfonic acid, an ammonia solution, or combinations of two or more thereof.

Water and volatiles are removed from the reaction mixture to obtain the hybrid siloxane oligomer product. Water can be removed from the mixture using any suitable agent such as, but not limited to, calcium carbonate, sodium bicarbonate, anhydrous sodium sulfate, and the like. Volatiles can be removed from the mixture using any suitable method as is known in the art. In one embodiment, volatiles are removed under pressure (i.e., at reduced pressure) and/or at elevated temperatures. The temperature may be selected as desired based on the solvent or other organic materials employed in the reaction mixture.

The hybrid oligomers may be employed to form a coating on a surface of an object. The oligomers can be provided as part of a coating composition. In hydrolytic condensation, one or more components of the coating composition are first hydrolyzed, followed by the condensation reaction with itself or other hydrolyzed and/or unhydrolyzed components of the coating composition.

The degree of cross linking can be evaluated based on the ratio of “T” units as evaluated by ²⁹Si NMR. It will be appreciated that the ratio of T°, T¹, T², and T³ units is indicative of the degree of cross linking in the system (i.e., the extent of hydrolysis and condensation in the product). This can be altered or controlled by reaction conditions including the dosage of catalyst and/or the time of the reaction. Generally, the degree of cross linking and the ratio of T°, T¹, T², and T³ units may be selected as desired for a particular purpose or intended application or coating application.

In one embodiment, the siloxane oligomers are present in the coating composition in an amount of from about 0.1 to 99 weight percent; from about 5 to about 90 weight percent; from about 15 to about 80 weight percent based on the total weight of the composition.

The coating compositions may optionally comprise one or more additives as desired to provide a particular effect or impart a particular property to the resulting coating. Examples of suitable additives include, but are not limited to, pigments, biocides, processing aids, surfactants, preservatives, flow and levelling agents, microbicides, fungicides, algaecides, nematodicites, molluscicides, matting agents, organic polymer particles, thixotropic additives, waxes, flame retardants, anti-stat agent, anti-sag agents, solvents, adhesion promoters, or combinations of two or more thereof.

Suitable solvents include water, alcohols, ketones, esters, amides, ether-alcohols, hydrocarbons, and mixtures thereof. Representative and non-limiting solvent include water, methanol, ethanol, propanol, isopropanol, butanol, ethylene glycol monoethyl ether, ethylene glycol monoethyl ether, ethylene glycol monopropyl ether, ethylene glycol monobutyl ether, ethylene glycol monohexyl ether, ethylene glycol mono-2-ethylhexyl ether, ethylene glycol monophenyl ether, diethylene glycol monoethyl ether, diethylene glycol monoethyl ether, diethylene glycol monopropyl ether, diethylene glycol monobutyl ether, butyl carbitol, dipropylene glycol dimethyl ether, butyl glycol, butyl diglycol, ethylene glycol monomethyl ether acetate, ethylene glycol monobutyl ether acetate, diethylene glycol monoethyl ether acetate, diethylene glycol monobutyl ether acetate, n-propyl acetate, n-butyl acetate, isobutyl acetate, methoxypropyl acetate, butyl cellosolve acetate, butylcarbitol acetate, propylene glycol n-butyl acetate, t-butyl acetate, propylene glycol, 2-butoxyethanol, methylethyl ketone, dimethyl ketone, ethyl acetate, ethyl propanoate, dimethylformanaide, toluene, xylene, mineral spirits, Papilla, and mixtures thereof. The solvent is present in the amount ranging from about 0.1 to about 99 weight percent, more specifically from about 5 to about 90 weight percent and even more specifically from about 15 to about 80 weight percent, based upon the total weight of the composition to which the solvent is to be added.

The composition can include filler as desired to impart particular properties as may be suitable for an intended use or application. The filler is not particularly limited and can be any inorganic or organic filler used to reinforce or extend the composition of the present invention. Typical fillers include, hut are not limited to, reinforcing fillers such as carbon black, fumed silica, precipitated silica, days, talc, aluminum silicates, metal oxides and hydroxides, and extending tillers such as treated and untreated calcium carbonates and the like. Fillers can be in the form of particulates, aggregates, agglomerates, platelets, and fibers. In one embodiment, one or more fillers are combined with silane coupling agents. The filler can be present in an amount of from about 0 to about 80 weight percent, from about 1 weight percent to about 70 weight percent, from about 5 weight percent to about 50 weight percent, from about 10 to about 40 weight percent based on the total weight of the composition.

The coating forming composition can be applied to a surface of a substrate employing any conventional or otherwise known technique such as, but not limited to, spraying, brushing, flow coating, dip-coating, physical vapor deposition, etc. The coating thicknesses of the as-applied (or wet) coating can be selected as desired and can be applied over a generally broad range, such as from about 10 to about 150, from about 20 to about 100, or from about 40 to about 80 microns. Wet coatings of such thicknesses will generally provide (dried) cured coatings having thicknesses ranging from about 1 to 30, from about 2 to about 20, or from about 5 to about 15 microns.

The surfaces coated with the present hybrid oligomers coating compositions can be selected as desired for a particular purpose or intended application. Examples of suitable materials that can be coated with the present compositions include, but are not limited to, a metal, a metal oxide, a glass, an enamel, a ceramic, a fiber, a textile, a fiber, a plastic, or a combination thereof. The shape and structure of the surface being coated is not particularly limited. The surfaces can be extended surfaces having a planar, substantially planar, or a contoured surface configuration. The surfaces can be spherical, elliptical, or oblong in shape. It will also be appreciated that the oligomers can be employed to coat particles of various sizes including, but not limited to, particles on the micron or submicron scale.

The coatings can impart a variety of properties to the surface to which they are applied including, but not limited to, hydrophobicity, oleophobicity, scratch resistance, anticorrosive properties, antifouling, antibacterial, antithrombic properties, anti-graffiti, drag-reduction, anti-icing, etc.

### EXAMPLES

Reference will now be made to the following Examples. The Examples are for the purpose of illustrating aspects and embodiments of the invention. They are not intended to be limiting examples of embodiments, features, or characteristics of the invention.

### Example 1: Synthesis of Hybrid Oligomer of Fluorosilane-Epoxy Silanes

Synthesis of hybrid oligomer fluorosilane-epoxy silane was performed by taking trimethoxy(3,3,4,4,5,5,6,6,7,7,8,8,8-tridecafluorooctyl)silane (10.0 g, 0.0213 mol), 3-glycidyloxypropyl) trimethoxysilane (1.68 g, 0.0071 mol), and 2, 2, 2 trifluoroethanol (3.0 g, 0.029 mol) as solvent in a round-bottomed flask and stirring for 30 minutes. To this reaction mixture, 400 μL of 5000 ppm trifluoroacetic acid as catalyst was charged, and stirring continued for 4 hours at 40° C. After that, the reaction mass was cooled to room temperature and quenched with 300 μL of 5000 ppm sodium bicarbonate solution. Further, the reaction mixture was dried with anhydrous sodium sulphate powder, and the solvent was evaporated using rotary evaporator under reduced pressure to obtain the colorless viscous liquid. The product was stored in a controlled temperature of 7-10° C. A similar procedure was followed for all the examples in Table 1.

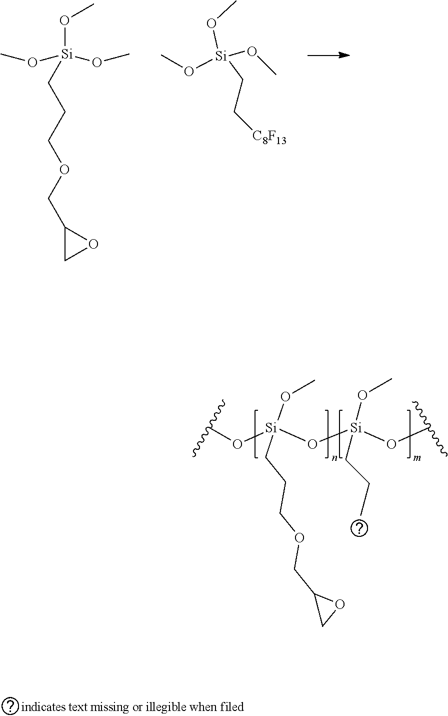

### Example 2: Synthesis of Hybrid Oligomer of Fluorosilane-Aminosilane 1

Synthesis of hybrid oligomer fluorosilane-aminosilane 1 was carried out by taking 3:2 molar ratio of trimethoxy(3,3,4,4,5,5,6,6,7,7,8,8,8-tridecafluorooctyl)silane (0.0113 mol), 3-aminopropyltriethoxysilane (0.0170 mol), and 2, 2, 2 trifluoroethanol (0.029 mol) into a round-bottomed flask and stirring for 30 minutes. To this reaction mixture, 400 μL of 0.05N ammonia solution was charged as catalyst and stirring was continued at room temperature for 4 hours. The reaction was quenched by removing the water content using anhydrous sodium sulphate and volatiles were removed under reduced pressure. The oligomer was isolated as a clear viscous liquid and stored in a controlled temperature of 7-10° C. The results are shown in Table 2.

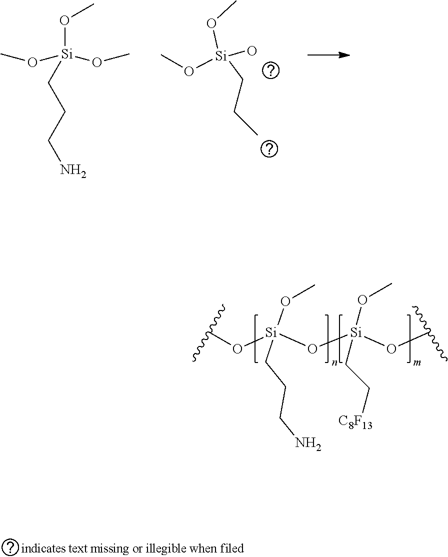

### Example 3: Synthesis of Hybrid Oligomer of Fluorosilane and Triaminosilane Silane

Synthesis of a hybrid oligomer fluorosilane-triaminosilane was carried out by taking 3:2 molar ratio of trimethoxy(3,3,4,4,5,5,6,6,7,7,8,8,8-tridecafluorooctyl)silane (0.0113 mol), diethylenetriaminopropyltrimethoxysilane (0.0170 mol), and 2, 2, 2 trifluoroethanol (0.029 mol) into a round-bottomed flask and stirring for 30 minutes. To this reaction mixture, 400 μL of 0.05 N ammonia solution was charged as catalyst and stirring continued at room temperature for 4 hours. The reaction was quenched by removing the water content using anhydrous sodium sulphate and volatiles were removed under reduced pressure. Oligomer was isolated as a clear viscous liquid and stored in a controlled temperature of 7-10° C. The results are shown in Table 3.

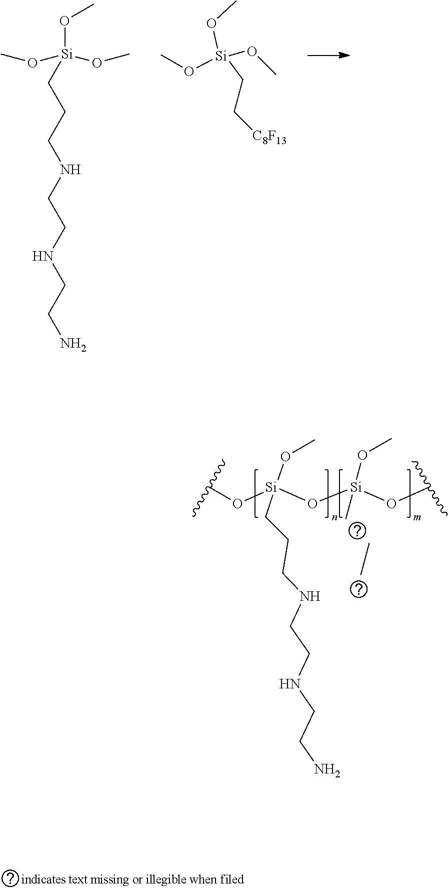

### Example 4: Synthesis of Hybrid Oligomer of Fluorosilane and Aminosilane 2

Synthesis of hybrid oligomer fluorosilane-aminosilane 2 was carried out by taking a 3:2 molar ratio of trimethoxy(3,3,4,4,5,5,6,6,7,7,8,8,8-tridecafluorooctyl)silane (15 g, 0.0320 mol), N-(ethyl)-gamma-aminoisobutyltrimethoxysilane (4.73 g, 0.0213 mol), and 2, 2, 2 trifluoroethanol (3 g, 0.029 mol) into a round-bottom flask and stirring for 30 minutes. To this reaction mixture, 400 μL of 0.05 N ammonia solution was charged as catalyst and stirring continued at room temperature for 4 hours. The reaction was quenched by removing the water content using anhydrous sodium sulphate and volatiles were removed under reduced pressure. The oligomer was isolated as a clear viscous liquid and stored in controlled temperature of 7-10° C. A similar procedure was followed for all the examples in Table 4.

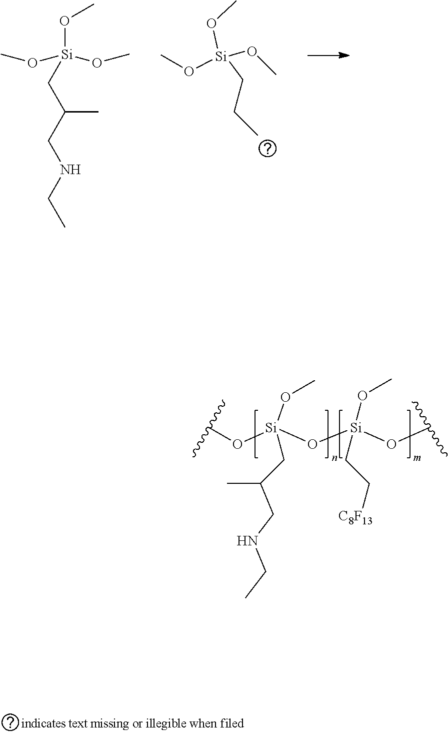

### Example 5: Synthesis of Hybrid Oligomer of Fluorosilane and Aminosilane 3

Synthesis of hybrid oligomer fluorosilane-aminosilane 3 was carried out by taking 3:2 molar ratio of trimethoxy(3,3,4,4,5,5,6,6,7,7,8,8,8-tridecafluorooctyl)silane (15 g, 0.0113 mol), (N,N-dimethyl-3-aminopropyl)trimethoxysilane) (4.3 g, 0.0170 mol), and 2, 2, 2 trifluoroethanol (3 g, 0.029 mol) into a round-bottomed flask and stirring for 30 minutes. To this reaction mixture, 400 μL of 0.05N ammonia solution was charged as catalyst and stirring continued at room temperature for 4 hours. The reaction was quenched by removing the water content using anhydrous sodium sulphate and volatiles were removed under reduced pressure. The oligomer was isolated as a clear viscous liquid and stored in controlled temperature of 7-10° C.

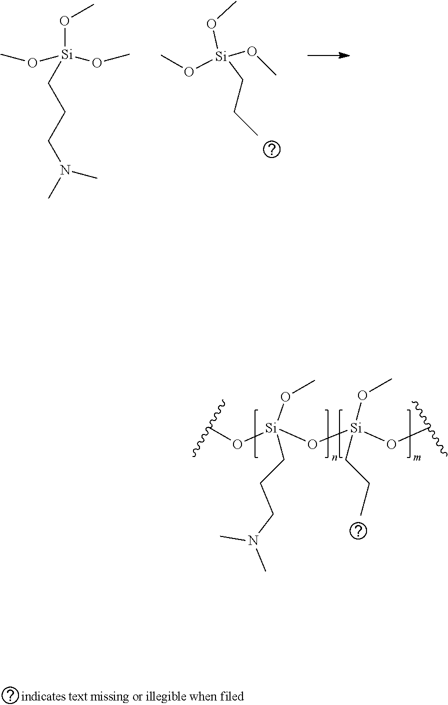

### Example 6: Synthesis of Hybrid Oligomer of Fluorosilane and Aminosilane 4

Synthesis of hybrid oligomer fluorosilane-aminosilane 4 was carried out by taking trimethoxy(3,3,4,4,5,5,6,6,7,7,8,8,8-tridecafluorooctyl)silane (20 g, 0.0427 mol) with 10 g of methanol. Then, 3 parts of water was added and the mixture was stirred at RT for 1 h. Then, (N-(beta-aminoethyl)-gamma-aminopropyltrimethoxysilane) (3.15 g, 0.0142 mol) was added and the mixture was stirred at RT for 1 h. Then, 1 part of water was added followed by stirring at RT for 1 h. The reaction mixture was refluxed for 3 h. Then, CaCO₃ was added and reflux was continued for 1 h. After filtration, stripping of volatiles was done at 85° C. under 10 mmHg. Results are shown in Table 5.

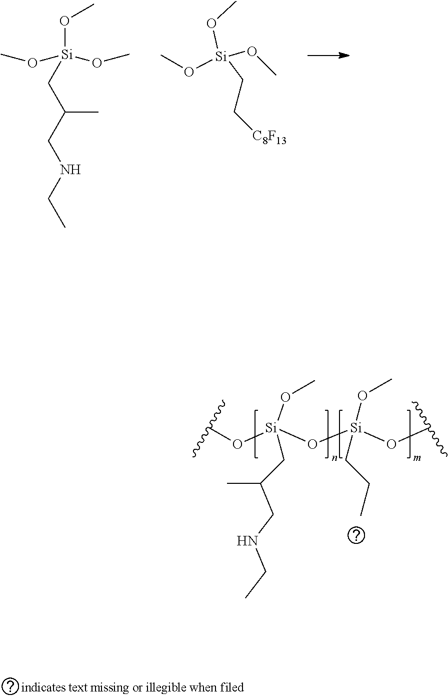

### Example 7: Synthesis of Hybrid Oligomer of Fluorosilane and Aminosilane 5

Synthesis of hybrid oligomer fluorosilane-aminosilane 5 was carried out by taking trimethoxy(3,3,4,4,5,5,6,6,7,7,8,8,8-tridecafluorooctyl)silane (20 g, 0.04270 mol) with 10 g of methanol. Then, 3 parts of water was added and the mixture was stirred at RT for 1 h. Then (N,N-dimethyl-3-aminopropyl)trimethoxysilane) (2.95 g, 0.0141 mol) was added to the mixture and stirred at RT for 1 h. Then 1 part of water was added followed by stirring at RT for 1 h. The reaction mixture was refluxed for 3 h. Then, CaCO₃ was added and reflux was continued for 1 h. After filtration, stripping of volatiles was done at 85° C. under 10 mmHg. Results are shown in Table 5.

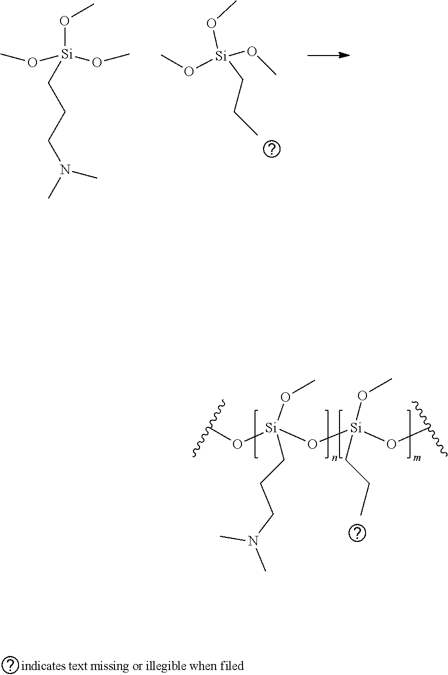

Physical Properties:

Hybrid silane oligomers containing organosilicon compounds were synthesized with various reactive functionalities, molar ratio combinations and molecular weight distributions. Viscosity refers to Brookfield viscosity evaluated using the cone-cup method. The degree of hydrolyzation/condensation is evaluated by ²⁹Si NMR. The list of examples are given below.

TABLE 1
List of examples of oligomer of trimethoxy(3,3,4,4,5,5,6,6,7,7,8,8,8-
tridecafluorooctyl)silane and 3-glycidoxypropyl trimethoxysilane.

| | Molar | | Si NMR | Solid | |
|---|---|---|---|---|---|
| | Ratio | Catalyst | (T⁰, T¹, | Content | Viscosity |
| Example | (Fluoro:Epoxy) | (ppm) | T², T³) | (%) | (PaS) |
| 1-1 | 3:1 | 140 | 13:28:31:27 | 83.43 | 0.0947 |
| 1-2 | 3:1 | 170 | 2:17:29:51 | 92.83 | 0.5471 |
| 1-3 | 3:2 | 120 | 52:25:16:6 | 56.81 | 0.0117 |
| 1-4 | 3:2 | 150 | 30:30:26:13 | 72.39 | 0.0266 |

TABLE 2
List of examples of oligomer of trimethoxy(3,3,4,4,5,5,6,6,7,7,8,8,8-
tridecafluorooctyl)silane and Gamma-aminopropyl
trimethoxysilane.

| | Molar | Si NMR | Solid | |
|---|---|---|---|---|
| | Ratio | (T⁰, T¹, | Content | Viscosity |
| Example | (Fluoro:amine) | T², T³) | (%) | (PaS) |
| 2-1 | 3:2 | 14:48:37 | 75.87 | 0.015 |

TABLE 3
List of examples of oligomer of trimethoxy(3,3,4,4,5,5,6,6,7,7,8,8,8-
tridecafluorooctyl)silane and diethylenetriaminopropylamino silane.

| | Molar | Si NMR | Solid | |
|---|---|---|---|---|
| | Ratio | (T⁰, T¹, | Content | Viscosity |
| Example | (Fluoro:amine) | T², T³) | (%) | (PaS) |
| 3-1 | 3:2 | 14:41:34:09 | 77.83 | 0.019 |

TABLE 4
List of examples of oligomer of trimethoxy(3,3,4,4,5,5,6,6,7,7,8,8,8-
tridecafluorooctyl)silane and N-ethyl-gamma-aminoisobutyl
trimethoxysilane.

| | Molar | | Si NMR | Solid | |
|---|---|---|---|---|---|
| | Ratio | Catalyst | (T⁰, T¹, | Content | Viscosity |
| Example | (Fluoro:amine) | (ppm) | T², T³) | (%) | (PaS) |
| 4-1 | 3:2 | 150 | 21:51:26:0 | 76.88 | 0.016 |
| 4-2 | 3:2 | 250 | 1:7:30:60 | 80.6 | 0.148 |
| 4-3 | 3:2 | 350 | 0:0:3:97 | 80.78 | 0.754 |
| 4-4 | 3:1 | 150 | 5:16:36:41 | 82.92 | 0.1171 |

Stability studies of the Examples 6 and 7 (hybrid oligomer of fluorosilane and aminosilane) at elevated temperatures (55 & 70° C.)

The examples 6 and 7 of hybrid oligomer of fluorosilane and aminosilane were analyzed for their shelf-life stability. For this study, the samples were aged at elevated temperature, 50 and 70° C. for a duration of up to 4 weeks. The samples were characterized by ²⁹Si NMR at different intervals to analyze the extent of further condensation by looking at the distribution of T species obtained upon condensation and thus stability of the samples was determined. It was observed that there was a minimal change in the distribution of the Si based T species upon ageing of the neat samples at elevated temperatures. Therefore, these samples could be stored at room temperature, without observing any significant further condensation.

TABLE 5
Stability Studies of hybrid oligomer
of fluorosilane and aminosilane

| | | ²⁹Si NMR | ²⁹Si NMR |
|---|---|---|---|
| | | Neat samples | Neat samples |
| | ²⁹Si NMR | (at 55° C.) | (at 70° C.) |
| | (after | (T⁰, T¹, | (T⁰, T¹, |
| Sample | synthesis) | T², T³) | T², T³) |
| Example 6 | 29:45:21:4 | 25:42:28:4 (2 w) | 23:47:27:3 (2 w) |
| | | 21:46:28:4 (4 w) | 17:45:32:5 (4 w) |
| Example 7 | 24:47:28:8 | 17:46:35:2 (2 w) | 18:44:34:3 (2 w) |
| | | 15:46:33:5 (4 w) | 13:47:34:5 (4 w) |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a hybrid siloxane oligomer, compositions thereof, coatings formed from such compositions, and articles comprising such coatings. Modifications may occur to those skilled in the art and to those who may make and use the invention. The disclosed embodiments are merely for illustrative purposes and not intended to limit the scope of the invention or the subject matter set forth in the claims.

1. A hybrid siloxane oligomer of the formula: 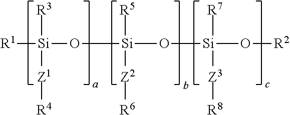
where R¹, R³, R⁵, and R⁷ are each independently selected from hydroxy, an alkoxy, an alkoxycarbonyl, a halide, an alkyl, an aralkyl, or an aromatic group, with the proviso that at least one of R¹, R³, R⁵, and/or R⁷ is an alkoxy, an alkoxycarbonyl, or a halide group;
R² is selected from hydrogen an alkyl, an aralkyl, or an aromatic group;
R⁴ is selected from a fluoro-functional group;
R⁶ and R⁸ are each independently selected from an alkoxy, an alkoxycarbonyl, a halide, an alkyl, an aralkyl, an aromatic group, an epoxy, a hydroxy, an amine containing group, a mercapto containing group, a urea containing group, a thiourea containing group, and a urethane containing group;
Z¹, Z², and Z³ are each independently selected from an organic linking group having 1-20 carbon atoms optionally containing heteroatoms, with the proviso that when R⁶ or R⁸ is an alkoxy, an alkoxycarbonyl, or a halide, then Z² or Z³, respectively, cannot be O, N, or S;
a is from greater than 0 to about 100, b and c are each independently 0 to about 100, a+b+c is greater than 0, and b+c is greater than 0.

2. The siloxane oligomer of claim 1, wherein R⁴ is a fluoroaliphatic group of the formula C_{z}H_{y}Fₓ where z is 1-20 and x+y is 2z+1 where x is 1 or greater.

3. The siloxane oligomer of claim 2, wherein R⁴ is selected from —CF₃, —C₂F₅, —C₃F₇, —C₄F₉, —C₅F₁₁, or —C₆F₁₃.

4. The siloxane oligomer of claim 1, wherein R⁶ and R⁸ are each independently selected from (i) an amine group selected from —NR₂¹², —(NR¹³)ₕ—NR¹⁴R¹⁵, —NR¹⁶—C(X¹)—NR₂¹⁷, —R¹⁸—N(R¹⁹)—R²⁰, —R²¹—NR₂²², —R²³—(N(R²⁴))ᵢ—R²⁵—N₂²⁶, or a combination of two or more thereof, where R¹², R¹³, R¹⁴, R¹⁵, R¹⁶, R¹⁷, R¹⁹, R²², R²⁴, and R²⁶ are each independently selected from hydrogen, C1-C20 alkyl, a C6-C20 cycloalkyl, or a C6-C20 aromatic, R¹⁸, R²⁰, R²¹, R²³, and R²⁵ are each independently selected from a divalent C1-C20 alkyl, a C6-C20 cycloalkyl, or a C6-C20 aromatic group, X¹ is O or S, h is 1 to about 10, and i is 1 to about 10; (ii) an epoxy functional group selected from —R²⁹-epoxy; or —R³⁰—O—R³¹-epoxy, where R²⁹, R³⁰, and R³¹ are each independently selected from a divalent C1-C20 alkyl, a C6-C20 cycloalkyl, or a C6-C20 aromatic, or wherein R²⁹ and R³¹ can optionally be a ring structure to form a C5-C20 cycloalkyl epoxy; and (iii) a thiol containing group selected from —SH, —SR²⁷, —S—C(O)—R²⁸, or a combination of two or more thereof, where R²⁷ and R²⁸ are each independently selected from a C1-C10 alkyl, a C6-C20 cycloalkyl, and a C6-C20 aromatic.

5. The siloxane oligomer of claim 1, wherein b is greater than 0 and R⁶ is selected from 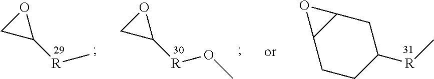
where R²⁹, R³⁰, and R³¹ are each independently selected from a divalent C1-C20 alkyl, a C6-C20 cycloalkyl, or a C6-C20 aromatic.

6. The siloxane oligomer of claim 4, wherein b is greater than 0, c is 0, and R⁶ is —R³⁰—O—R³¹-epoxy, where R³⁰ and R³¹ are each independently selected from a divalent C1-C20 alkyl, a C6-C20 cycloalkyl, or a C6-C20 aromatic.

7. The siloxane of claim 1, wherein b is greater than 0 and R⁶ is selected from —NR₂¹², —(NR¹³)ₕ—NR¹⁴R¹⁵, —NR₁₆—C(X¹)—NR₂¹⁷, —R¹⁸—N(R¹⁹)—R²⁰, —R²¹—NR₂²², —R²³—(N(R²⁴))ᵢ—R²⁵—NR₂²⁶, or a combination of two or more thereof, where R¹², R¹³, R¹⁴, R¹⁵, R¹⁶, R¹⁷, R¹⁹, R²², R²⁴ and R²⁶ are each independently selected from hydrogen, C1-C20 alkyl, a C6-C20 cycloalkyl, or a C6-C20 aromatic, R¹⁸, R²⁰, R²¹, R²³, and R²⁵ are each independently selected from a divalent C1-C20 alkyl, a C6-C20 cycloalkyl, or a C6-C20 aromatic group, X¹ is O or S, h is 1 to about 10, and i is 1 to about 10.

8. The siloxane of claim 7, wherein R⁶ is selected from —NH₂, —N(CH₃)₂, —NH—C(O)—NH₂, —NH—C(S)—NH₂, —(NH(C₂H₄)—)₂NH₂.

9. The siloxane oligomer of claim 1 wherein b is greater than 0, c is 0, and R⁶ is —NR₂¹² and R¹² is hydrogen or a C1-C20 alkyl.

10. The siloxane oligomer of claim 1, wherein b is greater than 0, c is 0, and R⁶ is —R¹⁸—N(R¹⁹)—R²⁰, or —R²³—(N(R²⁴))ᵢ—R²⁵—NR₂²⁶ where R¹⁹, R²², R²⁴, and R²⁶ are each hydrogen, and R¹⁸, R²⁰, and R²⁵ are each independently selected from a divalent C1-C20 alkyl

11. The siloxane oligomer of claim 1 having a molar ratio of R⁴:(R⁶+R⁸) of (i) from about 1:9 to about 9:1; (ii) from about 1:7 to about 7:1; (iii) from about 1:5 to about 5:1; (iv) from about from about 1:3 to about 3:1; (v) from about 1:2 to about 2:1; (vi) from about 1:1 to about 4:1; or (vii) from about 1.5:1 to about 3:1.

12. The siloxane of claim 1, wherein the siloxane has a number average molecular weight of from about 300 to about 10000.

13. A composition comprising the siloxane oligomer of claim 1 dispersed in a carrier.

14. The composition of claim 13 wherein the carrier is selected from an organic solvent.

15. A coating formed from the composition of claim 13.

16. An article comprising a coating on a surface thereof, wherein the coating is formed from a composition of claim 14.

17. A method of preparing a siloxane oligomer of claim 1 comprising:
(i) reacting a silane of the formula (R⁴—Z1)Si(OR³)₂(OR¹) with a silane of the formula (R⁶—Z²)Si(OR⁵)₃₋ₙ(OR²)ₙ and/or a silane of the formula (R⁸—Z³)Si(OR⁷)²(OR²) in the presence of a solvent and a catalyst;
(ii) removing water from the reaction mixture; and
(iii) removing volatile components from the reaction mixture.
